(19) United States
(12) Patent Application Publication
(10) Pub. No.: US 2006/0230553 A1
(43) Pub. Date: Oct. 19, 2006

(54) Process for tinting, dyeing or doping of moulded components made of transparent (co)polyamides in aqueous dye bath

(76) Inventors: Helmut Thullen, Bonaduz (CH); Friedrich Severin Buehler, Thusis (CH); Marcel Grand, Igis (CH)

Correspondence Address: John B. Hardaway, III;NEXSEN PRUET ADAMS KLEEMEIER LLC, P.O. Box 10107, Greenville, SC, 29603, US

(21) Appl. No.: 11/403,042

(22) Filed: Apr. 12, 2006

Related U.S. Application Data
(60) Provisional application No. 60/671,594, filed on Apr. 14, 2005.

(30) Foreign Application Priority Data
Apr. 14, 2005 (DE) 10 2005 017 321.7
Apr. 4, 2006 (DE) 10 2006 015 721.4

(51) Int. Cl. C09B 67/00

(52) U.S. Cl. 8/564

(57) ABSTRACT

The present invention relates to a novel composition of dye baths or processing baths and a process for tinting, dyeing or doping of moulded components with functional additives in these aqueous dipping baths or processing baths. The moulded components contain transparent or translucent (co)polyamides. If the moulded components should be tinted or dyed according to an embodiment of the invention, the dyeing can be performed as homogeneous dyeing or as gradient dyeing. The process according to the present invention is particularly suitable for producing high-value objects like ophthalmic lenses, sun lenses for eyeglasses, magnifying glasses, all kinds of inspection glasses, polarization films and display films, particularly if changing depths of color (gradients) are desired. This generating of a dyeing gradient requires dyeing in a dipping process, whereby the desired depth of color is achieved by multiple times of dipping the surface areas of the moulded article in the dye bath.

### FIELD OF INVENTION

The present invention relates to a novel composition of dye baths or processing baths and a process for tinting, dyeing or doping of moulded components with functional additives in these aqueous dipping baths or processing baths. The moulded components basically contain transparent or translucent (co)polyamides. The temperature of the dipping baths or processing baths is below the glass transition temperature (Tg) of the (co)polyamides. If the moulded components should be tinted or dyed according to an embodiment of the invention, the dyeing can be performed as homogeneous dyeing or as gradient dyeing.

The process according to the present invention is particularly suitable for producing high-value objects like ophthalmic lenses, tinted lenses for sunglasses, magnifying glasses, all kinds of inspection glasses, polarization films and display films, particularly if changing depths of color (gradients) should be generated.

This generating of a dyeing gradient requires dyeing in a dipping process, wherein the local desired depth of color is achieved by different times of dipping the surface areas of the moulded article in the dye bath.

Using dipping bath additives of a suitable combination of glycols and a special dipping process, homogeneous dye distribution is obtained in the moulded component or in a material composite containing this moulded component, wherein low haze values of □1% at color depths of 10 to 93% light transmission, preferably of 10 to 80% light transmission, particularly preferably of 10 to 60% light transmission are achieved, wherein a high gloss finished, and unobjectionable surface of the moulded

Using suitable basic colors all shades of color up to grey can be adjusted. Simultaneously, a dye bath suitable for processing is obtained that is stable for at least one week.

The moulded components or material composites dyed according to the present invention can be coated in conventional dipping baths without staining of dye with previous color and a hard lacquer that are cured thermally or by UV radiation. In the same way antireflection coatings or anti-fogging coatings can be deposited. The adhesion of these coatings is not affected by the dye. After the dip dyeing, polarization films can be affixed that are then finished with hard-coat and antireflection coatings and/or anti-fogging coatings.

However, it is also possible with the process according to the present invention to dope in moulded articles, like e.g. films, with functional additives, such as UV absorbers, photochromic or thermochromic additives, or additives enhancing contrast or additives affecting the refraction index. The process according to the present invention is particularly suited for dyeing monolayer cast films and as well for sensitive complex layer structures such as for displays of TFT (thin film transistor) screens. The refinement of the completely equipped multilayer films with hard lacquers, bloomings, antireflection coatings and/or water-repellent coatings and/or anti-fogging coatings works in the same way, i.e. in aqueous dipping baths.

Thus, the invention also concerns tinted, dyed or doped moulded components producible with aforesaid process. The moulded components according to the present invention can also be connected with at least one transparent or translucent surface layer or with decoration films, functional films or lacquers or synthetic materials, so that a material composite results that can be tinted, dyed or doped by the process as well.

The present invention concerns a tinted, dyed or doped moulded component, producible according to the process of the present invention.

The present invention concerns a moulded component which is connected with at least one transparent or translucent surface layer and/or with decoration films, functional films or lacquers or synthetic materials or other synthetic materials and results in a material composite that is tinted, dyed or doped by the process according to one of claims 1 to 29.

The present invention concerns a moulded component or a material composite which is used for optical components like ophthalmic lenses or tinted lenses for eyeglasses, magnifying glasses, lens systems, microscopes, cameras, displays for cellular phones, lenses for cameras, measuring devices, watch-glasses or watchcases, cases for handheld telephones with or without integrated displays, or any kind of devices, and for CD's, DVD's, lenses for LED's, beam waveguides, light couplers, light amplifiers, lenses and windows for lamps and laser devices, multilayer films, composite containers, and any kinds of transparent composites.

The present invention concerns a moulded component which is used for display or screen foils that subsequently can be laminated to multilayer display foils.

The present invention concerns a moulded component which is used as electroluminescent film, switching elements, apertures for heating/ventilation in the automotive industry or in the field of household items and telecommunication.

### BACKGROUND PRIOR ART

Transparent materials as polymethyl methacrylate (PMMA), polycarbonate (PC) and (co)polyamides (PA) are increasingly used for high-value applications such as optical lenses or tinted lenses for eyeglasses, compact discs, inspection glasses, cases for lamps, displays or flowmeters.

Transparent polyamide materials feature their low density, a high chemical resistance, an excellent dynamic loading capacity and toughness, and suitability for mechanical processing. Transparent polyamides, for example, are described in EP-A-1 369 447 and EP-A-0 725 101. Further refraction indices n_{D}²⁰ up to 1.65 can be adjusted by the choice of the monomers. EP-A-1 397 414 describes such polyamides.

Further improvements of properties of transparent polyamide materials can be obtained by producing transparent polyamide mixtures of amorphous, transparent and/or microcrystalline transparent and/or partial crystalline polyamides. Compositions of transparent polyamide blends can for example taken from EP-A-1 130 059.

Cycloaliphatic transparent polyamide materials and their transparent blends with up to 60% partial crystalline, aliphatic polyamide materials particularly feature an excellent UV stability of the material itself. All transparent polyamide materials can be improved with respect to their light resistance by UV stabilizators like HALS stabilizators, e.g. Nylostab SEED, Tinuvin 770 or UV absorber such as Tinuvin 360, Tinuvin 320, Tinuvin 312. Substituted tertiary butylphenols and their derivatives such as Irganox 1010, Irganox 1070 or Irganox 1098 exhibit good results for the stabilizing against heat effects. Optical brighteners such as Uvitex OB or Tinopal DMS-X or others are used in order to balance the yellow cast that is excited by the polyamide itself or by stabilizators. Optical brighteners can be completed or displaced by blue or violet dyestuffs.

For transparent materials in outdoor use, impermeability for harmful UV radiation below 430 nm, particularly below 400 nm and below 385 nm is increasingly asked for. That is achieved by incorporating common UV absorbers, particularly with chlorine activated benztriazoles such as Tinuvin 326, Tinuvin 327 or derivatives thereof. Also mixtures with HALS-types have proved themselves. The combination of optical brighteners and UV absorbers results in improved appearance of the moulded components with concurrent protection effect against harmful UV radiation.

As different UV protection classes are demanded on the market, it is advantageous to add the UV protection directly in terms of a suitable master batch before producing the moulded component. Depending on the amount of UV absorber in the master batch the light transmission for the protection class 385 nm, 400 nm or higher can directly be adjusted.

Known dyeing processes from the textile industry for polymers are performed with aqueous systems, wherein the dyeing temperature is selected such that it is between the melting point and Tg of the material to be dyed.

However, transparent amorphous materials can only be dyed in dipping baths with temperatures below glass transition temperature (Tg), because they lose their shape otherwise.

For the known lens material based on reactively cross-linked allyl diglycol carbonate with trade name CR 39, suitable dye baths are provided which, however, are not suitable for transparent polyamides, because they result in fissuring and haze, so that the dyed polyamide is not suitable for a lens use anymore.

U.S. Pat. No. 5,453,100 describes the dyeing of polycarbonate materials with dyestuffs by immersion in a mixture of dyestuff or pigment that is dissolved in a solvent mixture. The solvent mixture contains substances which are selected from dipropylene glycol monomethyl ether, tripropylene glycol monomethyl ether and propylene glycol monomethyl ether.

US 2004/016826 A1 describes a process for dyeing or tinting in a dye bath, wherein the dye bath contains:

50 to 90 wt % water,

0.1 to 15 wt % dyestuff,

2.5 to 20 wt % of a plasticizer conforming to the general formula
R¹—[(O(CH2)m)n-]OH,

wherein R′ is ethyl, propyl or butyl, m is 2 to 4 and n is 1 to 3, and 5 to 30 wt % of at least one leveling agent conforming to the general formula
H—[(O(CH2)m)n-]OH,

wherein m is 2 to 4 and n is 1 to 3.

However, US 2004/0168268 A1 does not describe the using of a buffer or the use of surfactants. Although the dye bath according to US 2004/0168268 A1 also may contain diethylene glycol or triethylene glycol, however, these components are used in amounts of 5 to 30 wt %.

In U.S. Pat. No. 6,749,646 a dye procedure for polycarbonate, polyester polycarbonate copolymers, SAN, ABS, ASA, polyamide, polyurethane or blends thereof is described that allows adjusting a color gradient. Examples and results however exclusively refer to polycarbonate.

The dye bath contains of 94 to 96 wt-% water with 0.1 to 15 wt-% dyestuffs and 1 to 2 wt-% carrier. Three to 4 wt-% of a surfactant can optionally be added. Water-insoluble dyestuffs with azo groups, diphenylamine and anthraquinone preparations are suggested as dyestuffs. The dyestuffs are first solved in a carrier and/or surfactant and then added to the water. Compounds according to following formula are claimed as preferred carriers:
R1 [—O—(CH2)n]mOR2
wherein R¹ and R² independently of each other denote H or C1-C18 alkyl, benzyl, benzoyl or phenyl-residue with n=1 or 2 and m=2 to 35. Surfactants are suggested optionally that can be ionic, amphoteric or nonionic.

For producing the dye bath, dyestuff and carrier are mixed and optionally, a surfactant is added. In the second step the water is added.

The dyeing method according to U.S. Pat. No. 6,749,646 contains the following steps:

a. producing the dye bath

b. heating up to 90 to 99° C. and immersing the moulded component

c. retaining the moulded component in the bath until the desired degree of tint is achieved

d. removing the moulded component from the bath.

U.S. Pat. No. 6,749,646 does not disclose the suitability of the procedure or the composition of the bath for polyamides, particularly for transparent polyamides. In the case of said transparent polyamides, the teaching of U.S. Pat. No. 6,749,646 provides no guidance about which dyeing system among the various possibilities should be used, so that the selection of the suitable system and of the three components dye, carrier, emulsifier requires extensive testing.

In the example itself, there is suggested that the instruction of the adding of the dye and of the mixing of the carrier with surfactant (Levegal, product from Bayer) have to be optimized for polycarbonate as well. If this optimization is not performed the moulded component takes up too little dye due to inadequate wetting.

Thus, for the person skilled in the art to develop the right procedure for each polymer type requires extensive trial and error.

### BRIEF SUMMARY OF THE OBJECT OF THE PRESENT INVENTION

The object of the present invention is to suggest compositions of aqueous dye baths and a method of dyeing moulded components made from transparent polyamides in which the dye baths remain stable for at least one week without components precipitating or changing the tint of color of the dyed moulded article; the surface of the moulded components retains in excellent quality, a gradient dyeing is possible and simultaneously such a strong adhesion of the dyestuff to the polymer is achieved that staining of dye in later steps of treating is avoided. In particular, also a process has to be found that allows a faster dyeing.

This object is solved by the processing bath according to claim 1 as well as the process according to claim 4. Furthermore the object is solved by the dyed moulded components according to claim 21.

In the dependent claims advantageous embodiments of the invention are described.

### DETAILED DESCRIPTION OF THE INVENTION

Therefore, the invention concerns a processing bath for dyeing or doping of moulded components consisting of following components in wt-%:

| A) | deionized water | | |
|---|---|---|---|
| B) | carrier | | 0.10-6.00, |
| | | preferred | 1.00-4.00, |
| | | particularly preferred | 1.00-3.00 |
| C) | emulsifier | | 0.001-1.00, |
| | | preferred | 0.001-0.50, |
| | | particularly preferred | 0.001-0.30 |
| D) | surfactant D | | 0.01-7.00, |
| | | preferred | 0.01-6.00, |
| | | more preferred | 0.50-4.00, |
| | | particularly preferred | 1.00-3.00 |
| E) | surfactant E | | 0.01-3.00, |
| | | preferred | 0.01-2.00, |
| | | more preferred | 0.05-1.00, |
| | | particularly preferred | 0.05-0.20 |
| F) | dyestuffs or doping | | 0.01-0.90, |
| | agents | | |
| | | preferred | 0.01-0.40, |
| | | particularly preferred | 0.01-0.20 |
| G) | buffer | | 0-3.00, |
| | | preferred | 0-2.0, |
| | | particularly preferred | 0-1.0, |

and if necessary,

| | | | |
|---|---|---|---|
| H) | dispersion agents for | | 0-4.00, |
| | dyestuffs or doping | | |
| | agents (F) | | |
| | | preferred | 0-3.00, |
| | | particularly preferred | 0-2.00 |

based on an anionic preparation of ethoxylated fatty amine esters, aralkyl polyglycolether and a modified polyalcohol.

The amounts of the components used are added up to 100 wt-%.

The deionized water A) can be prepared by distillation or ion exchanger.

The carrier B) consists of at least one monohydroxy glycol of the common formula (1):
R¹—{[—O—(CH₂)ₙ]ₘ} OR²
wherein n=2 to 18, m=1 to 4, R1=H and R2=an alkyl residue with C1-18, a benzyl, a benzoyl or a phenyl residue, wherein the aromatic ring can be substituted with alkyl or halogen.

The component C) emulsifier is selected from the group consisting of ionic emulsifiers, nonionic emulsifiers and amphoteric emulsifiers.

The surfactant D) consists of at least one glycol with two aliphatic or aliphatic-aromatic terminal groups of the common formula (2):
R¹—{[—O—(CH₂)ₙ]ₘ} OR²
wherein n=2 to 18, m=1 to 6, R¹ and R² are equal or different and denote an H, an alkyl residue with C₁₋₁₈, a benzyl, a benzoyl or a phenyl residue, wherein the aromatic ring can be substituted with alkyl or halogen.

The surfactant E) consists of at least one polyalkene glycol of the common formula (3):
R¹—{[—O—(CH₂)ₙ]ₘ}OR²
wherein R¹ and R²═H with n=2-4 and m=6-35.

The component F) is selected from the group consisting of the group of water soluble disperse dyes and/or from the group of water soluble acid dyes or the group of doping agents.

With the buffer G) selected from the group of buffer agents and/or aliphatic carboxylic acids and/or ammonium compounds and/or phosphates, a pH value of 3,5-7, preferable of 4-6 is adjusted.

The component H) can be added to the functional bath optionally. It is a special dispersion agent for disperse dyes and doping agents and is offered in trade with the name Univadine Top (Ciba Specialty Chemicals, Switzerland). This dispersion agent (H) is an anionic preparation of ethoxylated fatty amine esters, aralkyl polyglycolether and a modified polyalcohol. According to the safety data sheet of Univadine Top the composition contains of following components:

3-7% poly(oxy-1,2-ethanediyl)alpha-phenyl-omega-hydroxy-, styrentated,

>30% ethanol, 2,2′,2″-nitrilotris-, compound with alpha-(2,4,6-tris(2-phenylethenyl)phenyl)-omega-hydroxypoly(oxy-1,2-ethanediyl)phosphate, and

7% 2-methyl-2,4-pentanediol.

Surprisingly, a faster dyeing is achieved, namely as soon as 4 minutes instead of 30 minutes as usually, by this specific composition of the bath according to the invention with the components A) to H).

The dipping baths for pretreating or subsequent treating and cooling-down the moulded components consist of deionized water, if necessary 0.001-1.00 wt-% surfactants/emulsifiers are added.

The moulded components consist of transparent and translucent polyamides as described in EP-A-0 725 101, EP-A-1 369 447, EP-A-1 397 414 and EP-A-1 130 059.

In this application transparent, amorphous or microcrystalline polyamides or their transparent blends (mixtures) are preferred. They can be provided as transparent blends with partial crystalline polyamides such as PA12, PA11, PA6, PA1212, PA612.

Preferred amorphous or microcrystalline (co)polyamides feature the following compositions:

PA 6I, PA 6I/6T, PA MXDI/6I, PA MXDI/MXDT/6I/6T, PA MXDI/12I, PA MACMI/12, PA MACMI/MACMT/12, 6I/MACMI/12, PA 6I/6T/MACMI/MACMT/12, PA PACM6/11, PA PACM12, PA PACMI/PACM12, PA MACM6/11, PA MACM12, PA MACMI/MACM12, PA MACM12/PACM12, PA 6I/6T/PACMI/PACMT/PACM12/612.

For producing the functional bath the component A) is provided and the other components are mixed in under stirring.

The functional bath is heated indirectly because overheating in the area of the side of the bath can be obtained with directly heated baths which affects the stability of the bath in a negative way.

The procedure according to the present invention uses indirectly heated double-walled baths and for example water as heat transfer medium. In the internal space surrounded by heat transfer medium, the dyeing/doping liquor is located. The heat transfer medium is either rotated or stirred. The liquor is rotated or stirred separately. In laboratory test, advantageously, two beakers stacked into each other are used, wherein both vessels are stirred by separate magnets via a single magnetic stirrer with heater. This kind of device results in fundamentally higher stability of bath compared to directly heated baths. The heat transfer medium balances the gradient of temperature and avoids overheating.

Baths treated in that way can be cooled down to room temperature multiple times and be heated up to operating temperature again.

The dipping baths for pretreating or subsequently treating the moulded component can be directly as well as indirectly heated.

High differences of temperature between moulded component and treating bath generate dissatisfying results of the respective step of treatment because there are constantly changing conditions on the surface of the moulded component until the moulded component achieves bath temperature.

All baths are operated at a temperature between 50 and 95° C., excluding the subsequent bath treating, in which the temperature amounts to 30 to 60° C., and the cooling bath which is kept at room temperature.

The invention further concerns the use of the functional bath in a process for tinting, dyeing or doping of moulded components of transparent polyamides that comprises following steps:

a) preparing the dipping baths

b) heating-up the dipping baths

c) pretreating the moulded component

d) dyeing or doping the moulded component

e) subsequently treating the moulded component

f) cooling-down the moulded component

g) drying the moulded component

The process for dyeing or doping the moulded component in the functional bath produced according to the present invention is characterized by a pretreating and a subsequent treating of the moulded component to be dyed.

By pretreating, the moulded component is cleaned and heated to the temperature of the processing bath. If the temperature of the moulded component achieves the temperature of the processing bath it is removed from the pretreating bath and immediately immersed into the processing bath, in which it remains for 5 to 60 min. In the subsequent treating bath the moulded component is cleaned of excessive dyeing/doping liquor, before cooling-down to room temperature in the cooling bath. Finally, the moulded component is air dried or, e.g. in a weak warm air flow.

In a particular embodiment of the process according to the invention, a bath may be used for subsequently treating that contains a surfactant, e.g. sodium laurylsulfonate. Then, the moulded component is cleaned by ultrasonic waves in this bath, rinsed with distilled water and air dried.

If further steps of treatment follow it is advantageous to again preheat the moulded component to the respective bath temperature in which the next step of treating is performed. The process according to the present invention causes clearly better results compared to a process in which the moulded component is immersed into the dye bath at room temperature.

Furthermore, according to the present invention, further subsequent treating of the finally formed moulded components can be performed, e.g. lenses or multilayer films, as well as display films for TFT screens, by depositing of at least one hard lacquer coating and/or one blooming coating and/or one antireflection coating and/or water-repellent coatings and/or anti-fogging coatings, wherein, particularly, hard lacquer coatings with or without primary coatings and/or antireflection coatings are deposited in subsequent baths. These baths are based primarily on aqueous and organic solvents such as butanol, and reactive compounds such as isocyanates can be included.

Further functional coatings can be deposited on the moulded component by sputtering or vapor-depositing processes.

Monohydroxy glycols e.g. ethylene glycol monobutyl ether or diethylene glycol monobutyl ether are particularly suitable as carrier B).

Anionic surfactants such as soaps, alkyl benzene sulfonates, alkane sulfonates, alkyl sulfonates, alkyl ether sulfonates, cationic surfactants such as quaternary ammonium compounds with one or two hydrophobic groups, salts of long chained primary amines, nonionic surfactants such as fatty alcohol ethoxylates, alkyl phenol ethoxylates, sorbitan fatty acid esters, alkyl polyglycosides, N-methyl glucamides, amphoteric surfactants such as N-acylamido betaines and N-aminoxides are preferred as emulsifier C).

Soaps such as sodium lauryl sulfate or sulfonates are particularly preferred used.

Those glycols with formula (2) with n=2 to 4 are particularly suitable glycols as surfactant D), diethylene glycol or triethylene glycol, tetraethylene glycol, pentaethylene glycol, hexaethylene glycol are particularly preferred, diethylene glycol or triethylene glycol are still more preferred.

Polyethylene glycols with a molar mass from 280 to 1600 g/mol, particularly preferred with a molar mass from 280 to 600 g/mol, more preferred with a molar mass of 400 g/mol are particularly suitable as surfactant E). Such a product with a molar mass of 400 g/mol is available with the name Polyethylene 400 or PEG 400 (Fluka).

Disperse dyes can contain azo, anthraquinone, quinophthalone, methanyl, naphthol, naphthalamide, naphthaquinone or nitro dyes and are characterized in that they possess a low water solubility and are available in aqueous dye bath as dispersion. Therefor, these dyestuffs are subjected to a subsequent treating after the synthesis if necessary by milling to a particle size<1 μm to improve strength of color and homogeneity and to achieve the low water solubility. The milling is performed in aqueous suspension with dispersing agents as e.g. lignin sulfonates, condensates from naphthalene. Sulfuric acid and formaldehyde, condensates from ortho- and meta-cresol and 2-hydroynaphthalene-6-sulfonic acid, or mixtures of these products. Disperse dyes can be obtained e.g. under the trade name Terasil® (Ciba Spezialitaten-Chemie), Bemakron® (Bezema) or Foron® (Clariant). Foron types proved to be particularly suitable to achieve sufficient depth of color.

Also acid dyes can be utilized. Acid dyes are anionic dyestuffs and can contain azo, anthraquinone, quinophthalone, triphenyl methane and nitro groups. Mostly, they are available as Na-salts and are water soluble.

Dyestuffs from the group of the acid dyes can be obtained under the trade name Bezanyl (Bezema), Tectilon (Ciba Spezialitaten-Chemie) or Nylosan (Clariant).

Doping is to be understood as the use of the functional bath as means of transportation to incorporate doping agents as functional additives, e.g. compounds activable by laser, electronic compounds, photochromic or thermochromic additives, other temperature-sensitive compounds, additives enhancing contrast, optical functional additives or security features into the moulded component. Silver nitrate, lead tetraalkyls or iodine are preferred doping agents.

The moulded component has to be subsequently treated in a vapor of hydrochloric acid or sulfuric acid when using silver nitrate or lead tetraalkyls. This procedure is for example suitable adjusting the refractive index and Abbe number.

The moulded component has to be irradiated subsequently by laser light when using compounds activable by laser for labeling or marking at the surface or after the spray-coating in the internal space of the moulded components or for later joining procedures.

The optical functional additives are particularly suitable for displays, filters, flat screens or similar uses.

For example substances that cause an optical modification of the irradiated area by influence of harmful radiation as UV or radioactive radiation are possible security features. This effect can be used for producing lithographic films.

Soerensen buffer, acetate buffer, ammonium acetate, ammonium sulfate, sodium acetate, sodium sulfate or dihydrogen phosphate or hydrogen phosphate of potassium, sodium or ammonium are preferred buffer agents or acidifying agents as the buffer G); ammonium acetate, ammonium sulfate or potassium dihydrogen sulfate are particularly preferred.

Carboxylic acids with 1-3 C atoms are preferred as aliphatic carboxylic acids; formic acid or acetic acid is particularly preferred.

Buffers are added to retain the pH value of the dye or doping bath stable in a narrow pH range, e.g. when using pH sensitive dyestuffs, such as disperse dyes or functional additives.

The combination of the carrier(s), the surfactants D) and E) and the choice of the dye temperature are of great importance in the process according to the present invention to avoid haze, inhomogeneity or fissure at the surface of the moulded component.

The dye procedure according to the present invention can be used on the whole moulded component surface or just locally if the surface is covered with lithographic lacquers or matrices. The substances to be transported can be selected in that way that the adhesion properties at the wetted sites are modified compared to the covered sites. As a result covering of the press cylinder for the printing office becomes possible which uses the high abrasion resistance of for example polyamide 1 and 2 (example 1, 2).

Furthermore, the present invention concerns a process, wherein the transparent moulding materials used for producing the moulded articles already contain additives from the group of the heat stabilizers, the UV stabilizers, the optical brighteners, the slip additives, the dyestuffs, the agents for anti-fogging equipment, the phosphorus compounds, the metal flakes, the impact resisting modifiers, the nano-scaled functional and/or filling agents, or the reinforcing agents or the mixings thereof, and the group of the foreign polymers or the group of the thermotropic or thermochromic additives that modify the shade of color depending on temperature or on the wave length of the irradiated light, wherein the additives can be added preferably to the moulding materials by incorporating of a corresponding master batch.

According to the present invention, the UV equipment of the moulding materials for producing the moulded article is performed by the incorporating of 2 to 10 wt-% of the corresponding master batch before producing the moulded component. The master batch contains 5 to 20 wt-% of at least one UV stabilizer. The quality of the dispersion of the master batch in the melted polymer mass and the avoiding of disposal on the screw and in the tools are of great importance.

A master batch is used as a master batch whose carrier material contains the main material of the moulding material for the moulded component and additionally 5 to 50 wt-% of a low melting, partial crystalline, in the main component soluble, i.e. compatible synthetic material with a melting point below the Tg of the main component. The low melting synthetic material preferably concerns (co)polyamides.

Advantageously, this low melting component contains the common optical brighteners according to prior art and ensures their gentle incorporating and good dispersion. Typical adding amounts of this master batch to the main component of the moulded component range between 2 and 10 wt-%. This master batch supports the process of producing the moulded component by improved flowability in a positive way and improves the security against fracture of the moulded component.

The dyeing procedure according to the present invention is suitable for the dyeing of both ophthalmic (optical) lenses and sunglass lenses of polyamide.

It is particularly suitable for dyeing of optical polyamide lenses that are milled and polished to preferred diopters and thus, feature a modified surface compared with a lens produced by an injection moulding method. The additional components in the dyeing procedure according to the present invention, triethylene glycol and polyethylene glycol, re-smooth such surfaces. The polyamide 4 (example 4) shows a particular suitability for producing optical lenses with high hardness and high refraction index.

The dyeing procedure according to the present invention allows the dyeing of finished eyeglasses particularly for polyamide 1 and polyamide 2 (example 1 and 2) with the particular properties of low temperature toughness and dynamic fatigue strength for completely reversed bending stress. Polyamide 1 and polyamide 2 meet the demands for producing lenses and of glass frame and can even be produced completely with glasses by the injection moulding method. The complete eyeglasses can be dyed under the terms of the dyeing procedure according to the present invention homogeneously or with color gradients or with various colors, without weakening the high mechanical requirements upon the frame.

The dyeing procedure according to the present invention does not affect the mechanical security functions for lenses and safety lenses as security against fracture, for example measured after the shooting test according to ANSI 87, negatively and achieves values as prior to the dyeing in the functional bath according to the present invention.

The dyeing procedure according to the present invention is very gentle, it also allows dip dyeings of composites already laminated with polarizing films or back-moulded which possess very thin sensitive layer structures and possess up to 90° C. stable polarization coating based on oriented, iodine doped polyvinyl alcohol films for inner layer of a polarizer that can contain a polyamide, polycarbonate or PMMA outer layer.

The process according to the present invention is also particularly suitable for dyeing single-layer cast film and as well as for sensitive, complex layer structures, such as for displays of the TFT screens.

Polyamide 1, polyamide 2 and polyamide 3 and polyamide 4 are particularly suitable for such active display foils, with excellent safety properties or refraction indices, produced as high-purity cast films that subsequently are laminated to multilayer display foils. For example methylene chloride and/or trifluoroethanol and/or benzyl alcohol or mixtures thereof are suitable solvents for producing the 15 to 20 wt-% casting solution.

The producing of the homogeneous solution can be accelerated by pressure and temperature. A solution prepared in that way remains stable at room temperature as well and can be used in the casting process. Particularly a mixture of 3 parts methylene chloride and 2 parts trifluoroethanol leads to advantageous, filterable casting solutions for producing high-value optical safety films or dopable carrier films for display laminates from high transparent and mechanical stable polyamides.

Polyamides also are suitable for producing polarization films because, similar to polyvinyl alcohol, the separation of NH groups can be adjusted by the selected monomer as it is possible with the OH groups of the PVA. These NH groups can be doped with iodine like the OH-groups, e.g. by the process according to the present invention, and be caused to interact by variation of the NH distance. After orientating of a doped foil by drawing, a unidimensional conducting structure of the iodine is formed which results in a polarization of light.

Compared with a polarization film of PVA, a polarization film of polyamide possesses clear advantages concerning the mechanical properties, the water absorption, the thermal stability, the orientation and the chemical resistance. Polyamide films also can be utilized as suitable safety films that show no adhesion distortion on the polyamide polarization film. Dyeing, equipping and doping the films or laminates can be performed by the process according to the present invention. Each polyamide coating can be designed with arbitrary refraction indices of 1.50 to 1.65. The coatings can be additionally drawn and layered parallelly or perpendicularly to the orientation. Thereby certain grating or filter effects can be achieved. Such parallelly and/or perpendicularly layered polyamide films can be drawn uni or two-dimensional as laminate and yield a thickness of the single layer of for example 10 to 1000 nm, which results in interesting optical properties.

Display films based on polyamides with polyamide polarization layer permit in contrast to polarization films based on PVA to produce the rollable screen that is pulled from the ball pen or from the cellular phone. Active screens can be produced as goods on rolls in every dimension.

Polyamides possess particularly excellent properties for producing films and fibers by thermoplastic melt processing. Thus, alternative methods for producing in the production of cast films for monolayers or multilayer laminates become available, such as the production of mono or multilayer flat or blown film that clearly work more efficient, more economical and more environmentally sound.

The dyeing/doping procedure according to the present invention also allows the treatment of moulded components which are made from different transparent polyamides. This is particularly advantageous in extrusion or injection moulding of composite materials, wherein the different polyamides have to meet various demands and must not be changed by the functional bath.

Possible fields of application of the dyed moulded components besides lenses are:
switching elements and vents for heating/ventilation in the automotive industry or in the field of housewares and telecommunication,
electroluminescent films, e.g. display foils that afford extremely flat, luminous components without using LED's.

The present invention will now be illustrated in greater detail by means of the following examples, however, without limiting it thereto.

### EXAMPLES

### Example 1

### Producing Polyamide PA1

35.7 kg diamine MACM (3,3-diamino-4,4-dimethyl dicyclohexyl methane) and 34.2 kg dodecane dicarboxylic acid are mixed with 30 kg water in a 130 L autoclave with stirrer. After heating up to 280° C. and at a pressure of maximum 30 bar, preferred 20 bar, the formulation is released to normal pressure and degassed to the desired viscosity. The polymer melting mass is discharged in strands, cooled down in a water bath and granulated. After drying, a relative viscosity in 0.5% m-cresol of 1.73 and a Tg of 153° C. is achieved. The polyamide is amorphous and crystal clear.

On an Arburg injection moulding machine, round plate-shaped lenses 70×2 mm are produced in polished tool. The cylinder temperature is between 260 and 340° C. with tool temperatures between 45 and 140° C. These plate-shaped lenses have a haze of 0.30 and a light transmission of 94% and are dyed in the processing bath.

### Example 2

### Producing Polyamide PA2

23.0 kg diamine PACM (3,3-diamino dicyclohexyl methane) and 11.2 kg diamine MACM (3,3-diamino-4,4-dimethyl dicyclohexyl methane) and 35.7 kg dodecane dicarboxylic acid are mixed with 30.0 kg water in a 130 L autoclave with stirrer. After heating up to 280° C. and at a pressure of maximum 30 bar, preferred 20 bar, the formulation is released to normal pressure and degassed to the desired viscosity. The polymer melting mass is discharged in strands, cooled down in a water bath and granulated. After drying, a relative viscosity in 0.5% m-cresol of 1.85 and a Tg of 144° C. and melting point of 237° C. are achieved. The polyamide is microcrystalline and crystal clear.

### Example 3

### Producing Polyamide PA3

30.0 kg diamine MACM (3,3-diamino-4,4-dimethyl dicyclohexyl methane) and 20.7 kg isophthalic acid and 26.0 kg laurin lactam are mixed with 23.0 kg water in a 130 L autoclave with stirrer. After heating up to 280° C. and at a pressure of maximum 30 bar, preferred 20 bar, the formulation is released to normal pressure and degassed to the desired viscosity. The polymer melting mass is discharged in strands, cooled down in a water bath and granulated. After drying a relative viscosity in 0.5% m-cresol of 1.55 and a Tg of 160° C. are achieved. The polyamide is amorphous and crystal clear.

### Example 4

### Producing Polyamide PA4

In the solutizer of a 130 L pressure autoclave 10.0 kg hexamethylene diamine, 23.0 kg m-xylylene diamine, 42.4 kg isophthalic acid are suspended in 24.0 kg water and heated in 2 h to 140-180° C. and stirred, wherein a pressure is adjusted to about 3.5-10 bar. After giving the solution into the pressure autoclave, no pressure phase is run, but during the heating to 260° C. it is released simultaneously so that the pressure inside the pressure autoclave always is below 4 bar. Then stirring is continued and the pressure is lowered slowly to 1 bar and for circa another 3 h as it is degassed. After achieving the desired torque of the stirrer, the formulation is emptied through a nozzle with bores of about 5 mm. The resulting polymer strands are led through a water bath, cooled down and cut into granulate. Thereafter, it is dried for about 12 h at 100° C. in a tumbling dryer under nitrogen. A colorless, crystal clear, amorphous polyamide is formed, with a glass transition temperature of 160° C. and a relative viscosity of 1.36 measured in 0.5% m-cresol solution.

Plate-shaped lenses as in example 1 are made thereof, which have a haze of 0.50 and a light transmission of 92%.

### Example 5

### Dyeing in the Functional Bath with PA1

Producing functional baths no. 1-5

For producing the dye solution, 0.5 g disperse dye Foron® red RD-E (Clariant) is dispersed at 40 to 60° C. in deionized water under stirring.

For producing the dye liquor, components B) to E) and G) and deionized water are mixed in a 1 L beaker and heated up to 60° C. under stirring. 10 ppm sodium lauryl sulfate is used thereby as surfactant emulsifier C) and 9.08 g potassium dihydrogen phosphate as buffer G).

Following, the dye solution is added to the solution of the other components in the beaker. It is adjusted with deionized water to 1 L and heated to the dyeing temperature of 85° C.

Diethylene glycol monobutyl ether, triethylene glycol and polyethylene glycol 400 are utilized as carriers in amounts according to Table 1.

Table I shows the ratios of the components B), D) and E) in the experimental dye baths.

TABLE 1
Ratios of the components B), D) and E) (bath no. 1 is accordant
to the present invention)

| | diethylene glycol | | |
|---|---|---|---|
| bath | monobutyl ether | triethylene glycol | polyethylene glycol |
| no. | B) | D) | 400 E) |
| 1 | 20 g/l | 20 g/l | 1 g/l |
| 2 | 20 g/l | 20 g/l | |
| 3 | 20 g/l | | 1 g/l |
| 4 | | 20 g/l | 1 g/l |
| 5 | 20 g/l | | |

Method for Dyeing Plate-Shaped Lenses of PA1, 85° C./15 Minutes Dyeing Time

The moulded component is cleaned in distilled water that may include surfactants emulsifiers, fitted in a suitable holding device on a top cover and immersed in the heated, gently stirred dye bath at 85° C. After 15 minutes the moulded component is removed and cleaned with distilled water in an ultrasonic bath and dried on air.

The optical measurements were performed with a device type Byk Gardner haze-Gard Plus (manufacturer Byk-Gardner) according to ASTM D 1003.

| | haze | |
|---|---|---|
| | in % | light transmission in % |
| bath no. | after dyeing | After dyeing |
| | 0.80 | 54.6 |
| 2 | 6.70 | 48.6 |
| 3 | 2.30 | 51.0 |
| 4 | 0.90 | 86.0 |
| 5 | 1.60 | 48.8 |

Bath 1 results in haze<1% and light transmission<80%

Bath 2 results in haze>1%

Bath 3 results in haze>1%

Bath 4 results in haze<1% and a light transmission>80%

Bath 5 results in haze>1%

Result: Bath no. 1 with diethylene glycol monobutyl ether, triethylene glycol and polyethylene glycol (PEG 400) results in dyed plate-shaped lenses with low haze values at a high depth of color of 54% light transmission.

Bath no. 4 without diethylene glycol monobutyl ether results in a higher haze and a lower depth of color.

Especially bath 1 (according to the present invention) solves the object of the invention.

### Example 6

### Method for Dyeing Plate-Shaped Lenses PA4, 75° C./15 Minutes Immersion Time

The dye baths are produced according to example 1.

| | haze in % | Light transmission in % |
|---|---|---|
| bath no. | after dyeing | after dyeing |
| 1 | 0.70 | 55.3 |
| 2 | 1.20 | 54.4 |
| 3 | 2.10 | 51.8 |
| 4 | 0.70 | 80.6 |
| 5 | 2.40 | 53.5 |

Bath 1 results in haze<1% and a light transmission<80%
Bath 2 results in haze>1%
Bath 3 results in haze>1%
Bath 4 results in haze<1% and a light transmission>80%
Bath 5 results in haze>1%

Result: Bath 1 (according to the present invention) solves the object of the invention and affords at a haze<1% and a high depth of color.

### Example 7

### Producing the Functional Bath No. 6 (According to the Invention)

For preparing the dye suspension, 0.15 g in each case of the dyes Cibacet Blau EL-B, Cibacet Gelb EL-F2G, Cibacet Scharlach EL-F2G (disperse dyes, Ciba) as well as 0.3 g Benzanyl schwarz N-R (acid dye, Bezema) are added into a 200 ml beaker and replenished with 100 ml water. 1.5 g Univadine Top and 1.5 g Sandacid PB were added to the formulation.

Subsequently, the suspension was heated with careful stirring by means of magnetic stir bars up to 60° C. carefully, until a homogeneous dispersion was existent.

Subsequently, the suspension was added into a beaker filled with 900 ml water and preheated up to 60° C. and was heated up to 85° C. with stirring.

Then 10 ppm sodium laurylsulfonate are used as surfactant/emulsifier C) and 1.5 g Sandacid PB are used as buffer G). Diethylene glycolmonobutylether, triethylene glycol and polyethylene glycol 400 are utitilized as carriers in amounts according to Table 2. Table 2 represents the ratios of the components A) to H) in bath no. 6.

TABLE 2
Ratios of the components A) to H) (bath no. 6)

| | | | name of |
|---|---|---|---|
| component | g | | component |
| Cibacet Blau EL-B | 0.15 | disperse dye, Ciba | F |
| Cibacet Gelb EL-F2G | 0.15 | disperse dye, Ciba | F |
| Cibacet Scharlach EL-F2G | | disperse dye, Ciba | F |
| Benzanl scwarz N-R | 0.3 | acid dye, Bezema | F |
| Univadine Top | 1.5 | dispersion agent | H |
| | | for disperse dyes | |
| Sandacid PB | 1.5 | Buffer | G |
| *DEG-monobutylether | 40 | | B |
| **TEG | 60 | | D |
| **PEG | 24 | | E |
| Na-laurylsulfonate (ppm) | 10 | Tenside | C |
| Water deionized | 1000 | | A |

*DEG = diethylene glycol
**TEG = triethylene glycol
***PEG = polyethylene glycol

Component H=dispersion agents and stabilizing agents especially for disperse dyes.
Method for Dyeing for Plate-Shaped Lenses of PA1, 85° C./4 min dipping time

The moulded component (plate-shaped lens PA1) was dipped into the bath for 4 minutes, subsequently cleaned in an ultrasonic bath filled with distilled water and mixed with 50 ppm sodium laurylsulfonate, rinsed with distilled water and air dried.

The optical measurements were performed with a device type Byk Gardner haze-Gard Plus (manufacturer Byk-Gardner) according to ASTM D 1003.

Result:

| | |
|---|---|
| Transmission: | 43.1% (44.1%. 42.1%) |
| Haze: | 0.43% (0.42%. 0.44%) |
| Clarity: | 99.4% (99.4%. 99.4%) |

Thus, the conditions are met in clearly shorter dyeing time than in the aforementioned examples, namely transmission<80% and haze<1%.

Comparative Example According to U.S. Pat. No. 6,749,646 B2 (Prior Art)

Following dyeings from U.S. Pat. No. 6,749,646 B2 were reproduced:

Abstract of U.S. Pat. No. 6,749,646 B2, table 1, column 6, dyeing temperature 95° C.

| | | | light | |
|---|---|---|---|---|
| color from color- | name | | transmission | haze |
| index | Bayer (Lanxess) | time in min | in % | in % |
| Red G | Macrolex rot G | 10 | 32.7 | 2.5 |
| Red 5B | Macrolex rot 5B | 10 | 67.8 | 2.2 |
| Solven Green 3 | Macrolex grün 5B | 10 | 69.8 | 1.4 |
| Dispers violet 26 | Macrolex | 10 | 57.3 | 3.0 |
| | rotviolet R | | | |

Producing Dyeing Solution According to U.S. Pat. No. 6,749,646 B2

0.4% dyestuff was dissolved according to table 1, example with “RED 5B” with 66 g Levegal DLP (50 ml) by heating under stirring to 95° C., then added into a beaker with water (preheated to 95° C.) and replenished to one liter.

Method for Dyeing According to U.S. Pat. No. 6,749,646 B2

The moulded components, plate-shaped lenses with 2 mm thickness of PA1 were cleaned in distilled water and immersed into the slightly stirred dye bath with 95° C. After 10 minutes, as in Table 1, example with “RED 5B”, the moulded component was removed, cleaned in distilled water at 23° C. in a ultrasonic bath and dried with air.

For verification of the suitability of the process some examples from Table 1 of U.S. Pat. No. 6,749,646 B2 were reproduced. The table below contains the results of the re-enactments:

| | | light | |
|---|---|---|---|
| name Bayer | appearance predispersion or | transmission | |
| (Lanxess) | bath | in % | haze in % |
| Macrolex | bath: pearlescent suspension | — | — |
| rot G | with clearly visible organic | | |
| | and aqueous phases. Bath is | | |
| | unsuitable, therefore no | | |
| | dyeing | | |
| Macrolex | Bath: strong disposals, dye | 91.8 | 0.58 |
| rot 5B | precipitates | | |
| Macrolex | Predispersion of dye and | — | — |
| grun 5B | carrier(s) - stagnats after | | |
| | briefly allowing to stand. No | | |
| | bath could be prepared. | | |
| Macrolex | Bath: homogeneous, dark. | 80.6 | 0.66 |
| rotviolet R | After briefly allowing to stand | | |
| | the bath has a strong | | |
| | precipitation. | | |

None of the baths fulfills the condition for stability.

Modification of an example:

Mixing of 0.04% dye (instead of 0.4% according to table 1, example with “RED 5B”) with 66 g Levegal DLP (50 ml) by heating under stirring to 95° C., then added to a liter of water (preheated up to 95° C.). Such a dye concentration would be typical for dye liquors. Temperature: 95° C., time: 15 minutes

| | | light | |
|---|---|---|---|
| name | | transmission | haze |
| Bayer (Lanxess) | appearance predispersion or bath | in % | in % |
| Macrolex rot G | bath: clear solution | 87.4 | 0.34 |

Low haze values are achieved; however, the achievable depths of color are low and appear in a high light transmission.

### Example 8

### Stability of the Dye Baths According to the Present Invention

The dye bath no. 1 of the examples 5 and 6 was cooled down to room temperature after the dyeing and stored in a closed bottle. After seven days the dye bath again was heated to 85° C. and further dyeings were performed. The results are comparable to example 5. The dye bath shows no disposals on the walls and shows a minor precipitation that can be slightly stirred up before the re-use, though.

### Example 9

### Stability of Dyed Plate-Shaped Lenses Against Staining of Dye in Primer Solution

On each plates dyed with bath 1 according to example 5 and 6 one drop of following primers was applied for 30 sec:

CyrstalCoat PR 1133 (contains 70 to 77% water, 16 to 18% 2-butoxyl ethanol, 3 to 5% diethylene glycol monobutyl ether)

CrystalCoat PR 1135 (contains 70 to 72% water, 12 to 15% 2-butoxyl ethanol, 2 to 4% N-methylpyrrolidone)

CrystalCoat PR 1165 (contains 7 to 9% water, 30 to 35% isopropanol, 1 to 5% N-methylpyrrolidone, 30 to 60% 1-methoxy-2-propanol)

The drop was wiped after 30 seconds with suction paper tissues. The wiped primer shows no discoloration, nor by wiping under stronger manual pressure. Thus, no staining of dye occurs.

### Example 10

### Producing of a Master Batch for the UV Protection for Polyamide 1, 2, 3

8.1 kg polymer 1 and 1.0 kg Griltex 2 AGF (base material PA1 containing the optical brightener Blancophor) are mixed with 0.90 kg Tinuvin 326 for 30 minutes and extruded at 280° C. The strands are cooled down in the water bath after extruding, cut and dried. For equipping the polymer 1, 2 or 3 with UV protection (transmission at 400 nm<0.5%), 4% of this master batch is mixed with the rest of granulate and directly injection-moulded in the moulded component.

1. A processing bath for tinting, dyeing and doping of moulded components made from transparent or translucent (co)polyamides, wherein
said functional bath consists of the following components, in wt-%:

| A) | deionized water | | |
|---|---|---|---|
| B) | carrier | | 0.10-6.00, |
| C) | surfactant/emulsifier | | 0.001-1.00, |
| D) | surfactant D | | 0.01-7.00, |
| | | preferred | 0.01-6.00, |
| E) | surfactant E | | 0.01-3.00, |
| | | preferred | 0.01-2.00, |
| F) | dyestuffs or doping agents | | 0.01-0.90, |
| G) | buffer | | 0-3.00, |
| and if necessary, | | | |
| H) | dispersion agents for | | 0-4.00, |
| | dyestuffs or doping agents (F) | | |

based on an anionic preparation of ethoxylated fatty amine esters, aralkyl polyglycolether and a modified polyalcohol,
wherein the amounts of the components (A) to (G) and, if necessary, (H) total 100 wt-%,
wherein said carrier (B) consists of at least one monohydroxy glycol selected from the group consisting of ethylene glycol monobutyl ether and diethylene glycol monobutyl ether,
wherein said surfactant (D) consists of at least one glycol selected from the group consisting of diethylene glycol and triethylene glycol, and
wherein said surfactant (E) consists of at least one polyalkene glycol according to the general formula (3):
R¹—{[—O—(CH₂)ₙ]ₘ} OR²
wherein R¹ and R² denote H with n is 2-4 and m is 6-35.

2. The processing bath of claim 1, characterized in that the components are comprised in following quantities in wt %:

| A) | deionized water | | |
|---|---|---|---|
| B) | carrier | | 1.00-4.00, |
| | | preferred | 1.00-3.00, |
| C) | surfactant/emulsifier | | 0.001-0.50, |
| | | preferred | 0.001-0.30, |
| D) | surfactant D | | 0.50-4.00, |
| | | preferred | 1.00-3.00, |
| E) | surfactant E | | 0.05-1.00, |
| | | preferred | 0.05-0.20, |
| F) | dyestuffs or doping agents | | 0.01-0.40, |
| | | preferred | 0.01-0.20, |
| G) | buffer | | 0-2.0, |
| | | preferred | 0-1.0, |

and if necessary,

| | | | |
|---|---|---|---|
| H) | dispersion agents | | 0-3.00, |
| | | preferred | 0-2.00. |

3. The processing bath of claim 1, characterized in that it comprises a pH-value of 3.5 to 7.

4. The processing bath of claim 2, characterized in that it comprises a pH-value of 3.5 to 7.

5. A method of use of a processing bath in a process for tinting, dyeing or doping of moulded components with functional additives made of transparent or translucent (co)polyamides in aqueous dipping baths or functional baths comprising the following steps of:
a) providing the dipping or functional bath comprising water (A), buffer (G), a carrier (B), surfactants/emulsifiers (C), surfactants (D), (E), and at least one compound in sufficient quantity for tinting, dyeing or doping selected from the group of dyestuffs or doping agents (F), or of dye pigments, interference pigments, UV additives, photochromic or thermochromic additives, additives selected from the group of additives enhancing contrast or additives affecting refraction index, and if necessary, dispersion agents (H) for dyestuffs or doting agents based on an anionic preparation of ethoxylated fatty amine esters, aralkyl polyglycol ether and a modified polyalcohol.
b) heating-up said dipping or functional bath to a temperature of between 50 and 95° C.,
c) pretreating the moulded component in a dipping bath comprising water (A), surfactants and/or emulsifiers (C) for cleaning said moulded component, heating-up said dipping bath to a temperature of between 50 and 95° C., and removing said tempered and cleaned moulded component from said pretreating dipping bath,
d) immersing at least a portion of said moulded component in said processing bath, retaining the moulded component in said functional bath for a period of time of 5 to 60 minutes to allow that a sufficient quantity of said dyestuffs or doping agents (F), or said dye pigments, said interference pigments, of a UV additive, a photochromic or thermochromic additive, or an additive selected from the group of additives enhancing contrast or additives affecting refraction index can diffuse into the moulded component, and
e) removing said moulded component from said processing bath, and subsequent treating said moulded component,
f) cooling-down said moulded component, and
g) drying said moulded component,
wherein the moulded article comprises at least one thermoplastic synthetic material selected from the group of transparent (co)polyamides.

6. A method according to claim 5, characterized in that an additional subsequent cleaning process (e) of said dyed or doped moulded component is performed in a water bath that comprises surfactants, particularly sodium laurylsulfonate, and emulsifiers, a ultrasonic treatment is performed, and said moulded component is cooled down to room temperature.

7. The method of claim 6, characterized in that a further subsequent treating of the completely equipped moulded component is performed by depositing of at least one compound selected from the group consisting of hard lacquer coating, a blooming coating a antireflection coating a water-repellent coatings and an anti-fogging coatings, wherein, hard lacquer coatings with or without primary coatings and/or antireflection coatings are deposited in subsequent baths.

8. The method of claim 5, characterized in that additional functional coatings are deposited on said moulded component by sputtering or vapour-depositing processes.

9. The method of claim 5, characterized in that said processing bath comprises surfactants emulsifiers (C), selected from the group consisting of ionic tensides, amphoteric surfactants, and nonionic surfactants.

10. The method of claim 5, characterized in that the dyestuff is selected from the group of disperse dyes and of acid dyes.

11. The method of claim 5, characterized in that the transparent moulding material used for preparing the moulded article already comprises additives from the group consisting of stabilizers, UV stabilizers, optical brighteners, slip additives, dyestuffs, metal flakes, nano-scaled functional and/or filling agents, impact resisting modifiers or reinforcing agents or mixings thereof, wherein the additives are preferably added to the moulding materials by incorporating a corresponding master batch.

12. The method of claim 11, characterized in that the UV equipment of said moulding materials for preparing the moulded article has been performed by incorporating of 2 to 10 wt-% of the corresponding master batch before preparing the moulded component.

13. The method of claim 12, characterized in that a master batch based on polymer comprising the main material of moulding material for the moulded component and 5 to 50 wt-% of an additional low-melting, semi-crystalline, main-material-soluble synthetic material, with a melting point beneath the glass transition temperature (Tg) of the main component, is used as master batch.

14. The method of claim 5, characterized in that said moulded article contains titanium dioxide.

15. The method of claim 5, characterized in that polyethylene glycol 400 is used as polyalkylene glycol.

16. The method of claim 5, characterized in that solvents ethylene glycol monobutyl ether and/or diethylene glycol monobutyl ether in quantities of 0.1 to 6 wt-%, diethylene glycol and/or triethylene glycol in quantities of 0.01 to 7 wt-%, and at least one polyalkylene glycol according to formula (3) in quantities of 0.01 to 3 wt-% are present in the dye solution.

17. The method of claim 5, characterized in that said functional bath is prepared in such a way that component (A) is provided, and the other components are mixed in with stirring.

18. The method of claim 5, characterized in that said processing bath is indirectly heated.

19. The method of claim 5, characterized in that a moulded component is used as a moulded component that is connected with at least one material selected from the group consisting of transparent or translucent surface layer and/or with decoration films, functional films or lacquers or rubbers or other synthetic materials, and forms a material composite.

20. The method of claim 5, characterized in that said moulded component is a single-layer cast film.

21. The method of claim 5, characterized in that said transparent (co)polyamides are made from amorphous or microcrystalline polyamides or are present as their transparent mixture or are present as transparent blends with one or more semi crystalline polyamides from the group consisting of polyamide 12, polyamide 11, polyamide 6, polyamide 1212, polyamide 612 and preferably have following composition: PA 61, PA 6I/6T, PA MXDI/61, PA MXDI/MXDT/6I/6T, PA MXDI/121, PA MACMI/12, PA MACMI/MACMT/12, 6I/MACMI/12, PA 6I/6T/MACMI/MACMT/12, PA PACM6/11, PA PACM12, PA PACMI/PACM12, PA MACM6/11, PA MACM12, PA MACMI/MACM12, PA MACM12/PACM12, PA 6I/6T/PACMI/PACMT/PACM12/612.
